(19) United States
(12) Patent Application Publication
(10) Pub. No.: US 2025/0147864 A1
(43) Pub. Date: May 8, 2025

(54) SYSTEM AND METHOD FOR PERFORMING VALIDATIONS OF SOFTWARE

(71) Applicant: WOVEN BY TOYOTA, INC., Tokyo (JP)

(72) Inventors: Jean-François Bastien, Tokyo (JP); Caleb McGary, Tokyo (JP)

(73) Assignee: WOVEN BY TOYOTA, INC., Tokyo (JP)

(21) Appl. No.: 18/500,728

(22) Filed: Nov. 2, 2023

(51) Int. Cl. G06F 11/36

(52) U.S. Cl. CPC G06F 11/3612

(57) ABSTRACT

Provided are system, method, and device for performing validations of a system. According to embodiments, the system may include: a memory storage storing computer-executable instructions; and at least one processor communicatively coupled to the memory storage, wherein the at least one processor may be configured to execute the instructions to: receive at least one software part from a user; determine whether the received at least one software part passes a quality check; in response to determining that the received at least one software part passes the quality check: add the received software part to the list; and perform a first validation of the list; wherein each of the plurality of software parts specified in the list include one or more indication of a type of the quality check which a respective one of the plurality of software parts in the list passes.

### TECHNICAL FIELD

Systems, methods, and computer programs consistent with example embodiments of the present disclosure relate to software security, and more specifically, to dynamic validations of software.

### BACKGROUND

A software production line (SPL) refers to a software automation system comprising a set of processes, automation, and tailored tooling that allows its users (e.g., stakeholders and partners (OEMs and suppliers)) to continuously build, test and deliver a software stack. For example, an SPL for vehicle software allows its users to build, test and deliver a vehicle software stack for the electronic control units (ECUs) and microcontrollers (MCUs) in the vehicle. The software “production line” is, as its name suggests, analogous to a manufacturing production line where physical parts from suppliers are provided to the production line and are assembled into a final product with as much automation as possible.

The basic building block in the software production line is the software part. Software parts may refer to a source code repository with specific configurations. Software parts may be defined via a config file specified by the software production line. Software parts may be used to assemble software development kits (SDKs) which are a special type of software part containing other software parts (analogous to physical assemblies containing other physical parts). Software parts therefore may have dependencies between each other, and may be used in vehicles and their variants through configuration, and software may be built (compiled) to target the vehicles and their variants.

SPL provides tooling to build, test, and package these software parts as well as management of their dependencies. SPL may be used for vehicles, smartphones, IoT, and any entity that requires specific validatable and provable guarantees as part of its creation.

In practice, SDKs and software builds for the ECUs can be created from a large number of different combinations of different software parts. These SDKs and software builds must meet a broad variety of safety and security requirements, where each of the software parts that make up the SDKs and software builds must be tested both in isolation and as part of the combined package.

As such, there is a need to efficiently and effectively test each of the software parts that make up the SDKs and software builds, and to efficiently and easily identify any defects or errors in the software parts.

### SUMMARY

Example embodiments of the present disclosure automatically and dynamically perform validations of a software, based on results of quality checks performed on software parts that form the software. As such, example embodiments of the present disclosure allow for incremental updates and improvements of software over time while guaranteeing that the appropriate quality requirements are still being met.

According to embodiments, a system is provided. The system may include: a memory storage storing computer-executable instructions; and at least one processor communicatively coupled to the memory storage, wherein the at least one processor may be configured to execute the instructions to: receive at least one software part from a user, wherein the received at least one software part is a new version of at least one of a plurality of software parts specified in a list; determine whether the received at least one software part passes a quality check; in response to determining that the received at least one software part passes the quality check: add the received software part to the list; and perform a first validation of the list; wherein each of the plurality of software parts specified in the list include one or more indication of a type of the quality check which a respective one of the plurality of software parts in the list passes.

According to embodiments, a method is provided. The method may include: receiving at least one software part from a user, wherein the received at least one software part is a new version of at least one of a plurality of software parts specified in a list; determining whether the received at least one software part passes a quality check; in response to determining that the received at least one software part passes the quality check: adding the received software part to the list; and performing a first validation of the list; wherein each of the plurality of software parts specified in the list include one or more indication of a type of the quality check which a respective one of the plurality of software parts in the list passes.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 illustrates a block diagram of an example system configuration for performing validations of a software, according to one or more embodiments;

FIG. 2 illustrates a block diagram of example components in a SPL system, according to one or more embodiments;

FIG. 3 illustrates a block diagram of an example system configuration for performing validations of a software, according to one or more embodiments;

FIG. 4 illustrates a flow diagram of an example method for performing validations of a software, according to one or more embodiments;

FIG. 5 illustrates a flow diagram of a first example method for performing validations of a software and software parts, according to one or more embodiments;

FIG. 6 illustrates a flow diagram of a second example method for performing validations of a software and software parts, according to one or more embodiments;

FIG. 7 illustrates a flow diagram of a third example method for performing validations of a software and software parts, according to one or more embodiments; and

FIG. 8 illustrates a diagram of an example environment in which systems and/or methods, described herein, may be implemented.

### DETAILED DESCRIPTION

The following detailed description of example embodiments refers to the accompanying drawings. The same reference numbers in different drawings may identify the same or similar elements.

The foregoing disclosure provides illustration and description but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are disclosed in the specification, these combinations are not intended to limit the disclosure of possible implementations. In fact, many of these features may be combined in ways not specifically disclosed in the specification.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Systems, methods, devices, and the like, provided in the example embodiments of the present disclosure automatically and dynamically perform validations of a software, based on results of quality checks performs on software parts that form the software.

According to embodiments, the system may receive a new version of a software part that together with other software parts form a software; determine whether the received software part passes a quality check; and, in response to determining that the received software part passes the quality check, add the received software part to a list and perform a validation of the list.

Ultimately, example embodiments of the present disclosure automatically and dynamically perform validations of a software, based on results of quality checks performs on software parts that form the software, which allow for incremental updates and improvements of software over time while guaranteeing that the appropriate quality requirements are still being met.

It is contemplated that features, advantages, and significances of example embodiments described hereinabove are merely a portion of the present disclosure, and are not intended to be exhaustive or to limit the scope of the present disclosure.

Further descriptions of the features, components, configuration, operations, and implementations of the threshold tuning system of the present disclosure, according to one or more embodiments, are provided in the following.

### Example System Architecture

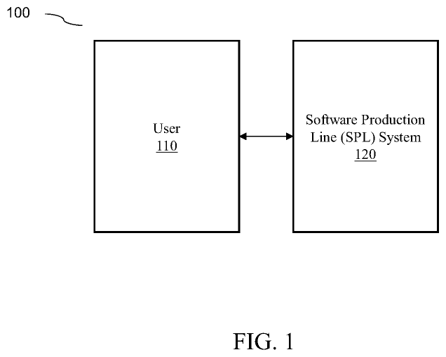

FIG. 1 illustrates a block diagram of an example system configuration 100 for performing validations of a software, according to one or more embodiments. As illustrated in FIG. 1, system configuration 100 may include a user 110 and a Software Production Line (SPL) System 120.

User 110 may include entities, such as Original Equipment Manufacturer, tier suppliers, etc. that are involved in the production of a software, and that provide at least one software parts that form the software. User 110 may be communicatively coupled to the SPL system 120. In some implementations, user 110 may provide software parts to the SPL system 120 and receive software builds, Software Bill of Material, etc. from the SPL system 120.

SPL system 120 may include a system, a platform, a module, or the like, which may be configured to perform one or more operations or actions for performing validations of a software. SPL system 120 may be a software automation system comprising a set of processes, automation, and tailored tooling that allows its users (e.g., stakeholders and partners (OEMs and suppliers)) to continuously build, test and deliver the vehicle software stack for the major electronic control units (ECUs) and microcontrollers (MCUs) in the vehicle.

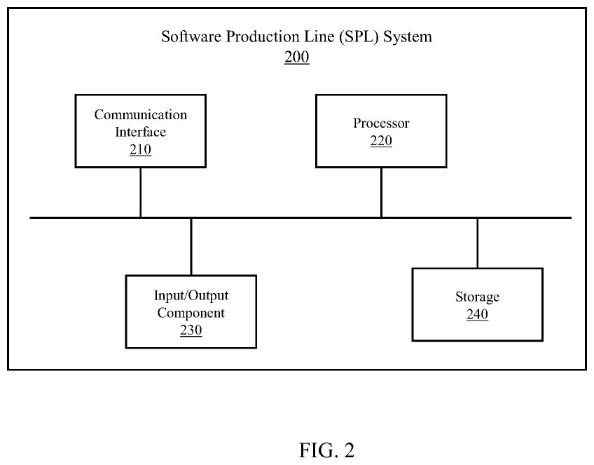

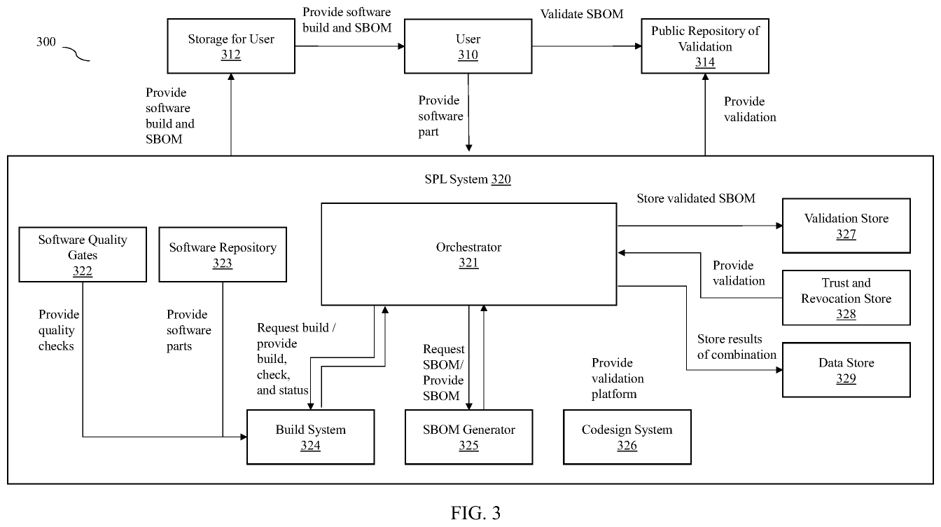

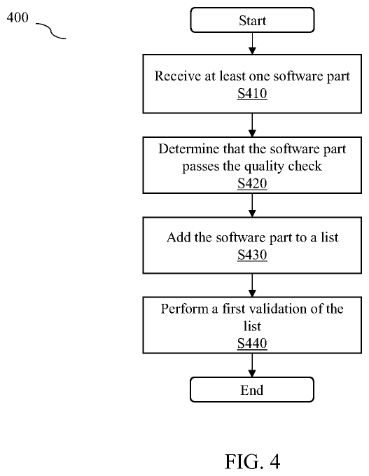

Example operations performable by the SPL system 120 for performing validations of a software are described below with reference to FIG. 4 to FIG. 7. Further, several example components which may be included in the SPL system 120, according to one or more embodiments, are described below with reference to FIG. 2 to FIG. 3.

FIG. 2 illustrates a block diagram of example components in a SPL system 200, according to one or more embodiments. The SPL system 200 may corresponds to the SPL system 120 in FIG. 1, thus the features associated with the SPL system 120 and the SPL system 200 may be similarly applicable to each other, unless being explicitly described otherwise.

As illustrated in FIG. 2, the SPL system 200 may include at least one communication interface 210, at least one processor 220, at least one input/output component 230, and at least one storage 240, although it can be understood that the SPL system 200 may include more or less components than as illustrated in FIG. 2, and/or may be arranged in a manner different from as illustrated in FIG. 2, without departing from the scope of the present disclosure.

The communication interface 210 may include at least one transceiver-like component (e.g., a transceiver, a separate receiver and transmitter, a bus, etc.) that enables the components of the SPL system 200 to communicate with each other and/or to communicate with one or more components external to the SPL system 200, such as via a wired connection, a wireless connection, or a combination of wired and wireless connections.

For instance, the communication interface 210 may couple the processor 220 to the storage 240 to thereby enable them to communicate and to interoperate with each other in performing one or more operations. As another example, communication interface 210 may couple the SPL system 200 (or one or more components included therein) to a device of the user 110, so as to enable them to communicate and to interoperate with each other.

According to one or more embodiments, the communication interface 210 may include one or more application programming interfaces (APIs) which allow the SPL system 200 (or one or more components included therein) to communicate with one or more software applications.

The input/output component 230 may include at least one component that permits the SPL system 200 to receive information and/or to provide output information. It can be understood that, in some embodiments, the input/output component 230 may include at least one input component (e.g., a touch screen display, a button, a switch, a microphone, a sensor, etc.) and at least one output component (e.g., a display, a speaker, one or more light-emitting diodes (LEDs), etc.), each of which may be separated from each other.

The storage 240 may include one or more storage mediums suitable for storing data, information, and/or computer-executable instructions therein. According to embodiments, the storage 240 may include at least one memory storage, such as a random access memory (RAM), a read only memory (ROM), and/or another type of dynamic or static storage device (e.g., a flash memory, a magnetic memory, and/or an optical memory) that stores information and/or instructions for use by the processor 220. Additionally or alternatively, the storage 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

According to embodiments, the storage 240 may be configured to store information, such as raw data, metadata, or the like. Additionally or alternatively, the storage 240 may be configured to store one or more information associated with one or more operations performed by the processor 220. For instance, the storage 240 may store information defining the historical operation(s) performed by the processor 220 to perform validations of a software, one or more results of operations performed by the processor 220, or the like. Further, the storage 240 may store data or information required in performing validations of a software.

In some implementation, the storage 240 may include a plurality of storage mediums, and the storage 240 may be configured to store a duplicate or a copy of at least a portion of the information in the plurality of storage mediums, for providing redundancy and for backing-up the information or the associated data. Furthermore, the storage 240 may also store computer-readable or computer-executable instructions which, when being executed by one or more processors (e.g., processor 220), causes the one or more processors to perform one or more actions/operations described herein

The processor 220 may include at least one processor capable of being programmed or being configured to perform a function(s) or an operation(s) described herein. For instance, the processor 220 may be configured to execute computer-executable instructions stored in at least one storage medium or a memory storage (e.g., storage 240, etc.) to thereby perform one or more actions or one or more operations described herein.

According to embodiments, the processor 220 may be configured to receive (e.g., via the communication interface 210, via the input/output component 230, etc.) one or more signals and/or one or more user inputs defining one or more instructions for performing one or more operations. Further, the processor 220 may be implemented in hardware, firmware, or a combination of hardware and software. For instance, processor 220 may include at least one of a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), and/or another type of processing or computing component.

According to embodiments, the processor 220 may be configured to collect, to extract, and/or to receive one or more information (in the form of signal or data, etc.) from the user 110, and to process the received one or more information to thereby perform validations of a software.

Descriptions of several example operations which may be performed by the processor 220 are provided below with reference to FIG. 4 to FIG. 7.

FIG. 3 illustrates a block diagram of an example system configuration 300 for performing validations of a software, according to one or more embodiments. As illustrated in FIG. 3, system configuration 300 may include a user 310, storage for user 312, public repository 314, and a SPL System 320.

The SPL system 320 may correspond to the SPL system 120 in FIG. 1 and SPL system 200 in FIG. 2, thus the features associated with the SPL system 120, the SPL system 200, and the SPL system 320 may be similarly applicable to each other, unless being explicitly described otherwise. Similarly user 310 may correspond to the user 110 in FIG. 1, thus the features associated with the user 110 and the user 310 may be similarly applicable to each other, unless being explicitly described otherwise.

As illustrated in FIG. 3, the SPL system 320 may be configured to receive software parts from the user 310. The SPL system 320 may also be configured to provide software builds and SBOMs to the user 310 via the storage for user 312, and may also be configured to provide data such as public keys to the public repository 314.

As further illustrated in FIG. 3, the SPL system 320 may include at least one orchestrator 321, the software quality gates 322, the software repository 323, the build system 324, the SBOM generator 325, the codesign system 326, the validation store 327, the trust and revocation store 328, and the data store 329, although it can be understood that the SPL system 320 may include more or less components than as illustrated in FIG. 3, and/or may be arranged in a manner different from as illustrated in FIG. 3, without departing from the scope of the present disclosure.

The SPL system 320 may be configured to receive the software parts from the user 310 and stores said software parts in the software repository 323. The software repository 323 may be configured to store a plurality of software parts required to build a plurality of software.

The orchestrator 321 may be configured to request and monitor a build of a software associated with the received software part from the build system 324, request a Software Bill of Material (SBOM) from the SBOM generator 325, store SBOMs and data required to perform validations (signatures, private keys, etc.) and time stamps in the validation store 327, and store results of the combinations of software parts in the data store 329. The orchestrator 321 may also be constantly aware of the state of all software parts, the quality checks perform for the software parts, and the results.

The build system 324 may be configured to obtain any software parts required to build said software from the software repository 323, obtain any defined quality checks stored in the software quality gates 322 in order to perform quality checks on the software parts, and provide the software builds, status of the builds, and results of the quality checks to the orchestrator 321.

The SBOM generator 325 may be configured to generate a SBOM associated with a software, and provide said SBOM to the orchestrator 321. The codesign system 326 may be configured to provide a platform for validations of the SBOM and the software parts. The trust and revocation store 328 may be configured to store a database of trusted and untrusted signatures, private keys, etc., for validations.

### Example Operations for Performing Validations of a Software in the Present Disclosure

In the following, several example operations performable by the SPL system of the present disclosure are described with reference to FIG. 4 to FIG. 7.

FIG. 4 illustrates a flow diagram of an example method 400 for performing validations of a software, according to one or more embodiments. One or more operations in method 400 may be performed by at least one processor (e.g., processor 220) of the SPL system.

As illustrated in FIG. 4, at operation S410, the at least one processor may be configured to receive at least one software part from a user. According to embodiments, software parts may refer to components or individual elements that together form a software. For example, a software part may refer to one or a combination of source code, build files, data, binaries, tools etc. that together form a software. According to embodiments, some of the software parts may be dependent from another software part. For example, a software part may require an input from another software part in order to operate, a software part may include another software part, an output from one software part (e.g., performance) may have an effect on an output of another software part, etc. According to embodiments, a software part may also refer to a software, which is part of another software.

According to embodiments, the software part received from the user at operation S410 may be a new version of one of a plurality of software parts that form a software. According to embodiments, the plurality of software parts that forms the software may be specified in a list, such as a Software Bill of Material (SBOM).

According to embodiments, the SBOM may refer to a metadata containing a library or a list of software parts that form a software. As such, the SBOM may be used to identify all components of a software of a product for various purposes, such as for recreating the software, identifying a software part that is known to be faulty during production, etc.

According to embodiments, the user may refer to an entity, such as OEM and tier supplier that owns the received software part.

The method then proceeds to operation S420.

At operation S420, the at least one processor may be configured to determine whether the received software part passes a quality check.

According to embodiments, the quality check may refer to a process for checking whether a software part meets associated standards. For example, the quality check may include one or more of security check, safety check, performance check, power consumption check, source code check, privacy check, etc. These checks may follow one or more associated industry standards. For example, the safety check may follow the Automotive Safety Integrity Level (ASIL) standards from ISO 26262, the security check may follow the defined requirements in the latest version of MISRA C++, the privacy check may follow the standards from ISO 2701, etc. According to embodiments, performing quality checks may also include executing linters as part of the software build, and running additional tooling as necessary.

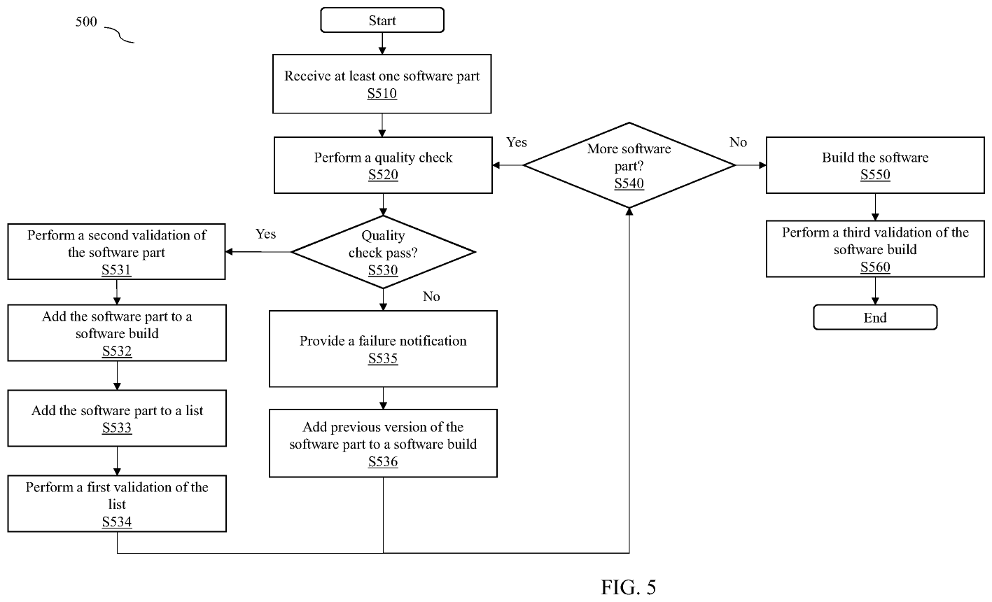

Additional descriptions regarding the process to determine whether the received software part passes the quality check are provided below with reference to FIG. 5 to FIG. 7.

It may be understood that the number of quality checks, the specific type of quality checks, and the specific standards for the quality checks that should be performed for a specific software part may be predefined by the entities involved in the production of the software and/or the defined standards in the industry based on the nature of the software and the software part. The method then proceeds to operation S430.

At operation S430, in response to determining that the received software part passes the quality check during operation S420, the at least one processor may be configured to add the received software part to the list. According to embodiments, the list may refer to a Software Bill of Material (SBOM). According to embodiments, the at least one processor may be configured to generate a new version of the list specifying the plurality of software parts that is specified in the previous version of the list along with the received software part.

The method then proceeds to operation S440.

At operation S440, the at least one processor may be configured to perform a first validation of the list. According to embodiments, the at least one processor may be configured to perform the first validation of the list by digitally signing the list (e.g., SBOM) as a whole. The list may be digitally signed directly (encrypting the list directly with a private key), or by using a hash algorithm (i.e., encrypting a hash of the list).

According to example embodiments, once a software part passes a type of quality check (e.g., security, safety, performance, power consumption, etc.), an entity that is responsible for performing said type of quality check may perform a validation (i.e., second validation) of said software part. According to example embodiments, said entity may refer to a checking entity in the SPL system. For example, said entity may refer to a machine, software, module, etc., that is part of the SPL system and that is designed to automatically perform a particular type of quality check on a software part. According to embodiments, said entity may refer to a human operating a machine, software, module, etc., that is part of the SPL system to manually perform a particular type of quality check on a software part. According to embodiments, said entity may refer to a checking entity that is external to the SPL system. For example, said entity may refer to OEM, tier supplier, government agencies, etc., that performs a particular type of quality check on a software part.

According to example embodiments, performing the second validation of a software part may refer to cryptographically signing the software part by the checking entity. According to example embodiments, performing the second validation may result in a cryptographic signature (or digital signature) being provided with respect to a cryptographic hash of a software part from the checking entity (i.e., the software part is hashed and the resulting hash is encrypted with a private key). According to another embodiment, the signature may be provided with respect to the software part itself, without hashing the software part.

It may be understood that each of the checking entities may have a unique key, such as a private key (of a public-private key pair) for providing a cryptographic signature (i.e., performing the second validation). It may also be understood that, if a checking entity is responsible for performing more than one type of quality check, such checking entity may have more than one cryptographic private key for providing more than one cryptographic signatures (where each key pair has a respective association with a type of quality check), with different cryptographic signatures being used when the checking entity performs different types of quality checks. For example, a checking entity may use a first private key for providing a first cryptographic signature when said checking entity performs a security check on a software part, and may use a second private key for providing a second cryptographic signature when said checking entity performs a safety check on the software part. As such, a particular cryptographic signature may indicate a particular type of the quality check that is performed on a software part, as well as a particular checking entity that performs such particular type of the quality check. Further, since a software part is cryptographically signed (second validation is performed) after the software part passes a type of quality check, existence of the resulting cryptographic signature may indicate that the software part passes the type of quality check. In other words, the second validation validates the software part passing the type of quality check. Further, it is understood that the same hash algorithm or different hash algorithms may be used/associated for each type of quality check and/or each checking entity.

In view of the above, it may be understood that each of the plurality of software parts in the list (including the software part received from the user at operation S410, which is added to the list at operation S430) may include one or more indication, such as a cryptographic signature, indicating a type of each quality check which it passes.

In this regard, at operation S440, the at least one processor may be configured to perform a first validation of the list in order to validate the second validations performed on all of the software parts specified in the list. According to example embodiments, a supervising entity in the SPL system may perform the first validation of the list. For example, said supervising entity may refer to a machine, software, module, etc., that is part of the SPL system and that is designed to automatically supervise the checking entities as well as the build of the software. According to example embodiments, said entity may refer to a human operating a machine, software, module, etc., that is part of the SPL system to manually supervise the checking entities as well as the build of the software.

According to example embodiments, performing the first validation may result in a cryptographic signature being provided with respect to the list by the supervising entity (e.g., a private key encryption of a hash of the list or at least a predefined portion of the list, generated by a predetermined hash algorithm). It may be understood that the supervising entity may have a unique key, such as a cryptographic private key for providing a cryptographic signature (i.e., performing the first validation), in a similar manner as the checking entity. According to example embodiments, the cryptographic signatures provided by the checking entities and the supervising entities may also indicate a date and time which the cryptographic signatures are provided.

In this regard, since the first validation is performed on the list that includes a plurality of software part that form a software, and since the first validation validates the second validations performed on all of the software parts specified in the list (which in turns validates the software part passing the quality checks), the first validation may validate the software as comprising software parts that appropriately meet various standards for quality (e.g., security, safety, performance, power consumption, etc.).

Accordingly, a cryptographic signature may have the following properties: data which the cryptographic signature is provided for, such as ECU software (source code, or compiled binary), software parts, software build, SBOM, and other signatures (e.g., a signor can sign the fact that another signor signed data); signor who performs the cryptographic signature using their private key (e.g., someone or entity that produces software, or is responsible for a quality gate, or is responsible for validating signatures); validator(s) who validates the signor (i.e., that the signor signed the data with their key); date at which the signature was provided; expiration date at which the signature is no longer considered valid (indicating that a software should not be used past said date); and revocation information (OSCP) for notifying when the signature should be revoked. It may be understood that the validators could be anyone or could be a list of specific public keys which correspond to other parties' private keys. Validators can be other suppliers, or OEMs, or public authorities, or the general public. For example, a first entity could validate or attest that a second entity wrote a particular software, or a supplier could validate or attest that the second entity ran particular tests on the supplier's software, or the first entity could validate or attest that the second entity validated a particular supplier's signature. Further, it may be understood that the date can be stored in a trusted store, for any entity to be able to validate a software when something was signed.

Upon performing operation S440, the method 400 may be ended or be terminated. Alternatively, method 400 may return to operation S410, such that the at least one processor may be configured to repeatedly perform, for at least a predetermined amount of time, the receiving the software part (at operation S410), the determining that the software part passes a quality check (at operation S420), the adding the software part to a list (at operation S430), and the performing a validation of the list (at operation S440). For instance, the at least one processor may continuously (or periodically) receive more new version of the same software part for the same software, more new version of a different software part for the software, and more new version of a software part for a different software.

To this end, the system of the present disclosure may perform validations of the software.

### Example Operations for Performing Validations of a Software and Software Parts in the Present Disclosure

In the following several example operations performable by the at least one processor for performing validations of a software and software parts are described with reference to FIG. 5 to FIG. 7.

FIG. 5 illustrates a flow diagram of an example method 500 for performing validations of a software and software parts, according to one or more embodiments. One or more operations of method 500 may be part of operation S410, S420, S430, and/or S440 in method 400, and may be performed by at least one processor (e.g., processor 220) of the SPL system.

As illustrated in FIG. 5, at operation S510, the at least one processor may be configured to receive at least one software part from a user. According to example embodiments, the received software parts may be a new version of one of a plurality of software parts that form a software, and the user may refer to an entity, such as OEM and tier supplier that owns the received software part, in the similar manner as operation S410 in method 400. The method then proceeds to operation S520.

At operation S520, the at least one processor may be configured to perform a quality check on the received software part. According to embodiments, the quality check may refer to a process for checking whether a software part meets associated standards, and may include one or more of security check, safety check, performance check, power consumption check, source code check, etc. in a similar manner as described in method 400. According to embodiments, the quality check may be performed by a checking entity in the SPL system, in a similar manner as described in method 400. The method then proceeds to operation S530.

At operation S530, the at least one processor may be configured to determine whether the received software part passes a quality check. According to embodiments, the at least one processor may be configured to determine whether the received software part passes the quality check by determining whether a result of performing the quality check on the received software part satisfies a threshold. According to embodiments, the threshold may be a quality gate.

According to embodiments, a quality gate may refer to a metric that defines a level of quality which a software part should meet. For example, once a quality check is performed on a software part and resulting data is produced, such resulting data may be processed to obtain a metric measurement indicative of a quality of such software part with regard to the type of the quality check performed (e.g., security, safety, performance, power consumption, etc.). Such metric may be compared to the quality gate in order to determine whether the quality of the software part meets an acceptable level. It may be understood that the quality gates may be predefined by the entities involved in the production of the software and/or the defined standards in the industry based on the nature of the software and the software part.

Accordingly, based on determining that the received software part passes the quality check, the at least one processor may determine that the quality of the software part with regard to a specific type of quality check (e.g., security, safety, performance, power consumption, etc.) meets an acceptable level, and proceeds to operation S531. On the other hand, based on determining that the received software part does not pass (fails) the quality check, the at least one processor may determine that the quality of the software part with regard to a specific type of quality check does not meet an acceptable level, and proceeds to operation S535.

According to embodiments, if a software part is defined (e.g., by the entities involved in the production of the software and/or the defined standards in the industry) to receive more than one type of quality checks, the at least one processor may proceeds to operation S531 if said software part passes all of the defined types of quality checks, and may proceeds to operation S535 if said software part fails any one of the defined types of quality checks.

At operation S531, the at least one processor may be configured to perform a second validation of the received software part based on a type of the quality check which the received at least one software part passes. According to embodiments, performing the second validation of the received software part may refer to a cryptographically signing the received software part by the checking entity, and may result in a cryptographic signature (or digital signature) being provided with respect to a cryptographic hash of the received software part and/or result in a cryptographic signature (or digital signature) being provided with respect to the software part itself, without hashing the software part, in the similar manner as described above in relation to method 400.

For example, as explained in relation to method 400, a checking entity may have a unique key, such as a private key (of a public-private key pair) for providing the cryptographic signature, and may have more than one cryptographic private key for providing more than one cryptographic signature, with different cryptographic signatures being used when the checking entity performs different types of quality checks. As such, for example, if a checking entity A uses a private key A to provide a cryptographic signature A when performing a safety check and uses a private key B to provide a cryptographic signature B when performing a security check, and if a software part passes the safety check performed by the checking entity A at operation S520, said checking entity A may cryptically sign the software part (i.e., the second validation) using the private key A to provide the cryptographic signature A. As another example, if a checking entity A uses a private key C to provide a cryptographic signature C when performing a safety check for a software part to be used in a software for testing, and uses a private key D to provide a cryptographic signature D when performing a safety check for a software part to be used in a software for final product. As such, when performing a safety check for a software part to be used in a software for testing, the checking entity A may use the private key C to provide the cryptographic signature C. The method then proceeds to operation S532.

At operation S532, the at least one processor may be configured to add the received software part to a build of a software. For example, since the received software part has passed the quality check and received the second validations during operations S520, S530, and S531, the at least one processor may determine that the received software part is at a quality that is acceptable to be included in the build of the software. Accordingly, the at least one processor may be configured to add the received software part to a build of a software. The method then proceeds to operation S533.

At operation S533, the at least one processor may be configured to add the received software part to a list. According to embodiments, the list may refer to an SBOM, in the similar manner as described in relation to method 400. The method then proceeds to operation S534.

At operation S534, the at least one processor may be configured to perform a first validation of the list. According to embodiments, the at least one processor may be configured to perform the first validation of the list by cryptographically (or digitally) signing the list to provide a cryptographic signature by the supervising entity, in the similar manner as described in relation to method 400. The method then proceeds to operation S540.

At operation S535, the at least one processor may be configured to provide a failure notification to the user. According to embodiments, the failure notification may indicate the type of the quality check which the received software part fails. For example, if the received software part fails a security check, the at least one processor may be configured to provide a failure notification to the user, indicating that the received software part fails the security check. According to embodiments, the failure notification may include any additional information related to the failure, such as the checking entity that performs the quality check, the defined quality gates, the standards used for the quality check, etc. The method then proceeds to operation S536.

At operation S536, the at least one processor may be configured to add a previous version of the received software part to a build of a software. For example, since the received software part has failed the quality check during operations S520 and S530, the at least one processor may determine that the received software part is at a quality that is not acceptable to be included in the build of the software. Accordingly, the at least one processor may be configured to add a previous version of the received software part to a build of a software, which is assumed to have already passed the quality check. The method then proceeds to operation S540.

At operation S540, the at least one processor may be configured to determine whether there are any more software part received from the user. Accordingly, based on determining that there are more software part received from the user, the method returns to operation S520 to perform the quality check on the remaining software part received from the user. On the other hand, based on determining that there no more software part received from the user, the method proceeds to operation S550.

At operation S550, the at least one processor may be configured to build the software. According to embodiments, the at least one processor may be configured to build the software based on the plurality of software parts specified in the list, including the new version of the software part added to the list and the build during operations S532 and S533. For example, if a software comprises of software part A version 1.0, software part B version 1.0, and software part C version 1.0, specified in a SBOM, and a new version of software part A version 1.0, software part A version 1.1, is received from the user, passed the quality check, and added to the SBOM and the build during operations S510-S534, the at least one processor may be configured to build the software using software part A version 1.1, software part B version 1.0, and software part C version 1.0. The method then proceeds to operation S560.

At operation S560, the at least one processor may be configured to perform a third validation of the build of the software. According to embodiments, the at least one processor may be configured to perform the third validation of the build of the software by cryptographically (or digitally) signing the build of the software to provide a cryptographic signature by the supervising entity, in the similar manner as described in relation to the first validation.

Upon performing operation S560, the method 500 may be ended or be terminated. Alternatively, method 500 may return to operation S510, such that the at least one processor may be configured to repeatedly perform, for at least a predetermined amount of time, the receiving the software part (at operation S510), the performing the quality check (at operation 520), the determining whether the software part passes the quality check (at operation S530), the performing the second validation of the software part (at operation S531), the adding the software part to the build (at operation S532), the adding the software part to the list (at operation S533), the performing the first validation of the list (at operation S534), the providing the failure notification to the user (at operation S535), the adding the previous version of the software part to the build (at operation S536), the determining whether there are any more software part received from the user (at operation S540), the building the software (at operation S550), and the performing the third validation of the build (at operation S560). For instance, the at least one processor may continuously (or periodically) receive more new version of the same software part for the same software, and more new version of a software part for a different software.

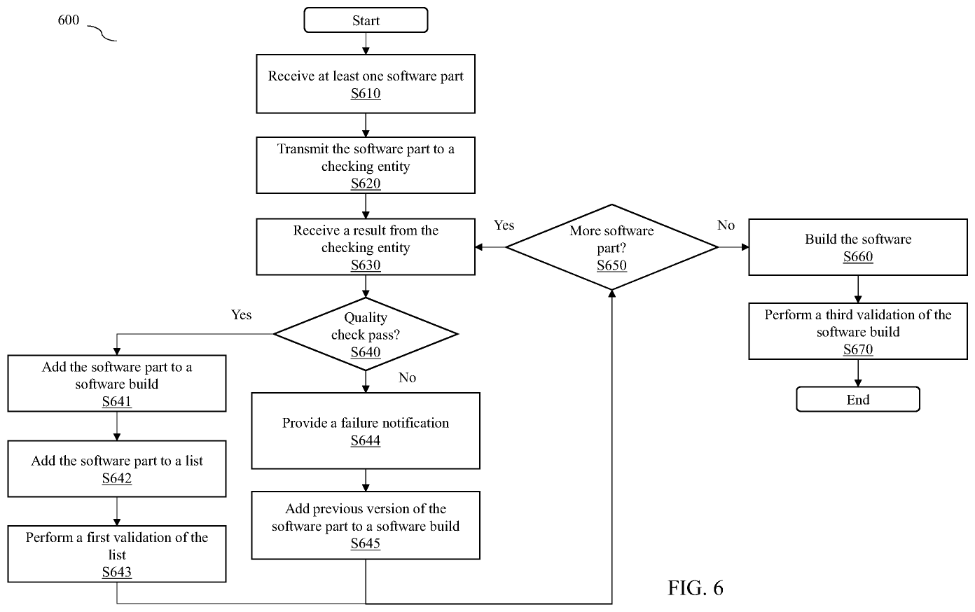

FIG. 6 illustrates a flow diagram of an example method 600 for performing validations of a software and software parts, according to one or more embodiments. One or more operations of method 600 may be part of operation S410, S420, S430, and/or S440 in method 400, and may be performed by at least one processor (e.g., processor 220) of the SPL system.

As illustrated in FIG. 6, at operation S610, the at least one processor may be configured to receive at least one software part from a user. According to embodiments, the received software parts may be a new version of one of a plurality of software parts that form a software, and the user may refer to an entity, such as OEM and tier supplier that owns the received software part, in the similar manner as operation S410 in method 400. The method then proceeds to operation S620.

At operation S620, the at least one processor may be configured to transmit the received software part to a checking entity. According to embodiments, the checking entity may refer to a checking entity that is external to the SPL system, as described in relation to method 400.

It may be understood that the checking entity external to the SPL system may perform a quality check on the received software part, determine whether the received software part passes a quality check, and perform a second validation of the received software part based on a type of the quality check which the received software part passes, in the similar manner as described for the checking entity in the SPL system described in relation to method 500. The method then proceeds to operation S630.

At operation S630, the at least one processor may be configured to receive a result of performing a quality check on the received software part from the checking entity. According to embodiments, if the received software part passes a quality check, the result received from the checking entity may indicate that the checking entity has performed the second validation for the received software part based on a type of the quality check which the received software part passes. For example, the result received from the checking entity may include a cryptographic signature that results from the checking entity cryptographically signing the received software part, where inclusion of such cryptographic signature indicates that the checking entity has cryptographically signed (i.e., performed the second validation of) the received software part. According to embodiments, if the received software part fails a quality check, the result received from the checking entity may indicate that the received software part fails a quality check. For example, the result received from the checking entity may include a notification indicating that the received software part fails a quality check. According to embodiments, the result received from the checking entity may include any additional information related to the quality check, such as the checking entity that performs the quality check, the defined quality gates, the standards used for the quality check, etc. The method then proceeds to operation S640.

At operation S640, the at least one processor may be configured to determine whether the received software part passes a quality check. According to embodiments, the at least one processor may be configured to determine whether the received software part passes a quality check by determining whether the result received from the checking entity indicate that the checking entity has performed the second validation for the received software part or that the received software part fails a quality check.

Accordingly, based on determining that the received software part passes the quality check, the method proceeds to operation S641. On the other hand, based on determining that the received software part does not pass (fails) the quality check, the method proceeds to operation S644.

It may be understood that operations S641, S642, S643, S644, S645, S650, S660, and S670 in method 600 may be similar to operations S532, S533, S534, S535, S536, S540, S550, and S560 in method 500. Thus, descriptions regarding said steps are omitted.

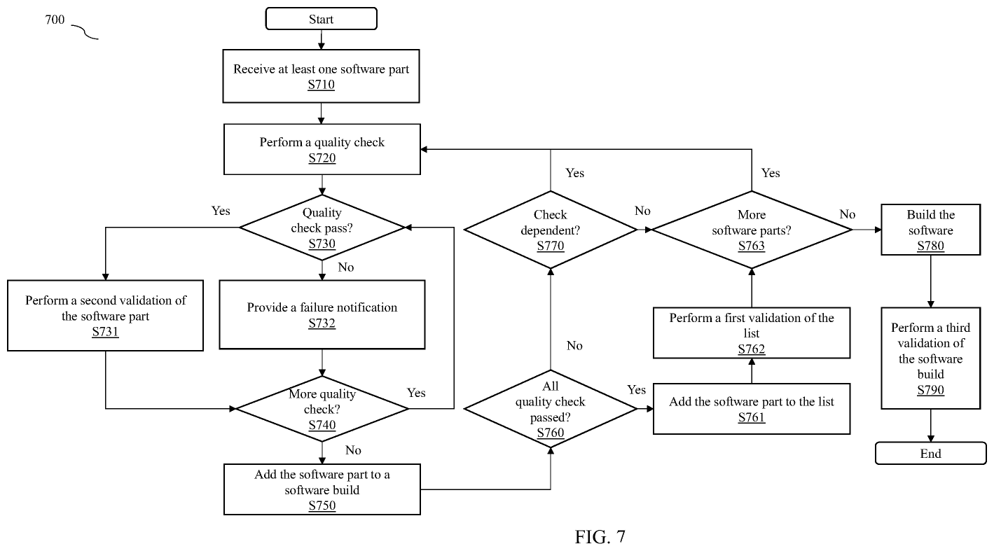

FIG. 7 illustrates a flow diagram of an example method 700 for performing validations of a software and software parts, according to one or more embodiments. One or more operations of method 700 may be part of operation S410, S420, S430, and/or S440 in method 400, and may be performed by at least one processor (e.g., processor 220) of the SPL system.

As illustrated in FIG. 7, at operation S710, the at least one processor may be configured to receive at least one software part from a user. According to embodiments, the received software parts may be a new version of one of a plurality of software parts that form a software, and the user may refer to an entity, such as OEM and tier supplier that owns the received software part, in the similar manner as operation S410 in method 400. The method then proceeds to operation S720.

At operation S720, the at least one processor may be configured to perform a quality check on the received software part. According to embodiments, the quality check may refer to a process for checking whether a software part meets associated standards, and may include one or more of security check, safety check, performance check, power consumption check, source code check, etc. in a similar manner as described in method 400. According to embodiments, the quality check may be performed by a checking entity in the SPL system, in a similar manner as described in method 400. The method then proceeds to operation S730.

At operation S730, the at least one processor may be configured to determine whether the received software part passes a quality check. According to embodiments, the at least one processor may be configured to determine whether the received software part passes the quality check by determining whether a result of performing the quality check on the received software part satisfies a threshold, in the similar manner as described in relation to method 500.

Accordingly, based on determining that the received software part passes the quality check, the at least one processor may determine that the quality of the software part with regard to a specific type of quality check (e.g., security, safety, performance, power consumption, etc.) meets an acceptable level, and proceeds to operation S731. On the other hand, based on determining that the received software part does not pass (fails) the quality check, the at least one processor may determine that the quality of the software part with regard to a specific type of quality check does not meet an acceptable level, and proceeds to operation S732.

At operation S731, the at least one processor may be configured to perform a second validation of the received software part based on a type of the quality check which the received at least one software part passes. According to embodiments, performing the second validation of the received software part may refer to a cryptographically signing the received software part by the checking entity, and may result in a cryptographic signature (or digital signature) being provided with respect to a cryptographic hash of the received software part and/or result in a cryptographic signature (or digital signature) being provided with respect to the software part itself, without hashing the software part, in the similar manner as described above in relation to method 400. The method then proceeds to operation S740.

At operation S732, the at least one processor may be configured to provide a failure notification to the user. According to embodiments, the failure notification may indicate the type of the quality check which the received software part fails, in the similar manner as described in relation to method 500. The method then proceeds to operation S740.

At operation S740, the at least one processor may be configured to determine whether there are more quality check to perform on the received software part. According to embodiments, if a software part is defined (e.g., by the entities involved in the production of the software and/or the defined standards in the industry) to receive more than one type of quality checks, the at least one processor may individually check each of the quality checks during operation S730, and may proceeds to operation S531 or operation S535 for each of the quality checks.

Accordingly, based on determining that there are more quality check to perform on the received software part, the method returns to operation S730 to perform such additional quality check. On the other hand, based on determining that there are no more quality check to perform on the received software part, the method proceeds to operation S750.

In view of the above process, for example, if a software part is defined to receive the security check, the safety check, and the performance check, and if said software part passes the security check, passes the safety check, but fails the performance check, said software part would include two cryptographic signatures (resulting from the same checking entity or different checking entities cryptographically signing the software part) indicating that the software part passes the security check and the safety check during operation S731. Further, the SPL system would provide a failure notification to the user indicating that the software part fails the performance check during operation S732. The method then proceeds to operation S750.

At operation S750, the at least one processor may be configured to add the received software part to a build of a software, in the similar manner as explained in relation to method 500. The method then proceeds to operation S760.

At operation S760, the at least one processor may be configured to determine whether the received software part passes all of the defined quality checks. Accordingly, based on determining that the received software part passes all of the defined quality checks, the method proceeds to operation S761. On the other hand, based on determining that the received software part does not pass all of the defined quality checks, the method proceeds to operation S770.

At operation S770, the at least one processor may be configured determine whether the received software part has at least one dependent software part that should receive quality check. According to embodiments, the at least one processor may be configured determine whether the received software part has at least one dependent software part that should receive quality check based on a type of the quality check which the received software part fails.

According to embodiments, the dependent software part may refer to a software part in the plurality of software parts specified in the list that form the software, and that is dependent from another software part. According to embodiments, the dependent software part may be defined by the entities involved in the production of the software and/or the defined standards in the industry to receive a particular quality check or all quality checks if a software part which the dependent software part depends from fails a particular quality check.

For example, a software part B may be required to meet a performance check, and may have received and passed such performance check previously. However, the performance of the software part B may be dependent on the performance of another software part A. In this regard, if a new version of software part A is received from the user during operation S710 and fails the performance check during operation S720 and S730, the software part B (which depends from software part A) may no longer meet its performance check if the new version of software part A is incorporated into the build and software part B is made to depend from it. Accordingly, software part B may be defined to receive the performance check if software part A fails its performance check. Further, it may be understood that, if software part A passes the performance check, even if software part A fails another quality check (e.g., a safety check), software part B may not need to receive a quality check.

According to embodiments, the at least one processor may be configured determine whether the received software part has at least one dependent software part that should receive quality check, as long as the received software part fails at least one of the defined quality checks. For example, the dependent software part may be defined by the entities involved in the production of the software and/or the defined standards in the industry to always receive a particular quality check or all quality checks if a software part which the dependent software part depends from fails any quality check. It may be understood that, in such case, operation S760 may be skipped.

Accordingly, based on determining that the received software part has at least one dependent software part that should receive quality check, the method returns to operation S720 to perform such quality check on the dependent software part. On the other hand, based on determining that the received software part has no dependent software part that should receive quality check, the method proceeds to operation S763. It may also be understood that, if a software part does not have any dependent software part, the method may proceeds to operation S763.

It may be understood that operations S761, S762, S763, S780, and S790 in method 700 may be similar to operations S533, S534, S540, S550, and S560 in method 500. Thus, descriptions regarding said steps are omitted.

It can be understood that the configurations illustrated in FIG. 5 to FIG. 7 are simplified for descriptive purpose, and is not intended to limit the scope of the present disclosure in any way. Specifically, in practice, different aspects of method 500, 600, and 700 may be combined or interchangeable with one another.

For example, one software part in a software may be checked by the checking entity in the SPL in the manner described in method 500, and another software part in the same software may be checked by the checking entity external to the SPL in the manner described in method 600 system. Similarly, one type of quality check for a software part may be performed by checking entity in the SPL in the manner described in method 500, and another type of quality check for the same software part may be checked by the checking entity external to the SPL system in the manner described in method 600.

As another example, while method 700 is described with operation S720 to perform the quality check on the received software part, method 700 may be modified to instead transmit the received software part to an external checking entity and receive a result from the external checking entity in the similar manner as described during operations S620 and S630 in method 600.

Further, as described in relation to method 400, the at least one processor may be configured to generate a new version of the list specifying the plurality of software parts that is specified in the previous version of the list along with the received software part. In this regard, while methods 500, 600, and 700 describe that the list may be generated sequentially (where each of the new versions of each of the software parts are incrementally added to the list), the list may also be generated in parallel (where each of the new versions of each of the software parts are separately added to the list). Further, each of the new versions of the list may be signed, and may be added to another list together, which is also signed.

It may be understood that, once the software and the SBOM (e.g., list) are generated according to the processes in methods 500, 600, and 700, said software and the SBOM may be provided to the user (e.g., OEM, tier suppliers, etc.), such that said user may verify and utilize said software. Similarly, a product utilizing the software may also include the software itself along with the SBOM, such that the sellers and buyers of said product may verify and utilize said product.

Further, it may be understood that the public key and cryptographic signatures for the checking entities and supervising entities may be provided to a public repository, such that an end user (e.g., OEM, tier suppliers, seller of products, buyers of products, etc.) can verify that the cryptographic signatures provided in relation to the SBOM are valid.

It may be understood that the list (e.g., SBOM) and the software generated in the manner described according to the processes in methods 500, 600, and 700 may provide software (supply) chain security, and may have the following advantageous.

Since all new versions of all software parts that pass the quality checks are added to the SBOM (which is then signed with a cryptographic signature), the above methods allow for incremental updates and improvements of software over time while guaranteeing that the appropriate quality requirements are still being met.

In particular, for example, if any of the software parts includes an error or becomes corrupted, or an attacker adds a malicious software part into a software in order to comprises the software (and subsequently an end product utilizing the software), such issues can be detected and the SBOM of the software utilizing such compromised software part may not be signed. Accordingly, the end user (a seller of a product utilizing the software, the buyer of the product, etc.) is able to determine that the software utilizing such compromised software part is not appropriate for use by checking that the corresponding SBOM is not signed (or that there are no signed SBOM for such a software). As such, the above processes allow for detection of malicious or erroneous issues in a software, and the SBOM generated in accordance with the above processes provides a way to create a specific attestation as to the quality, safety and compliance with any specific standard of a software in a centralized system (which can be attested to by the user).

Further, since the SBOM generated in accordance with the above processes may indicate which software part (and version) passed the quality check, which quality check was passed, and who is the entity that gave that pass, such SBOM may be used to identify liability and accountability foe the checking entities and supervising entities.

Furthermore, since the SBOM generated in accordance with the above processes may indicate which version of the software part passed the quality check and if the quality check is provided for testing or final product, such SBOM may be used to identify whether the software is appropriate for a product (e.g., if the product is a final product to be released to consumers, the quality checks performed on the software parts should be for final product, rather than for testing).

Further still, the SBOM generated in accordance with the above processes may also allow for: dynamic management of dependent software parts; dynamic management of required quality gates for production of an SDK; evolution of software component sources, dependencies, and quality gates over time; automated real time feedback on the status of passing quality checks; past states for combinations of software parts to be retrieved from a data store; option for manual checks with the results being validated by a human; SBOM to serve as auditable means of validating files that are part of release; use of cryptographic signatures to validate passing of quality checks and overall quality of the software; use of public repository where entities can validate signature and time when release was signed; supplier, external auditor, or other third party to build the software having the same end result; a class of end user like an auditor to validate the contents and testing performed on a particular software package in a reproducible manner; and software to be automatically managed via a signature and allow for its use to be restricted, revoked, or granted accordingly.

### Example Implementation Environment

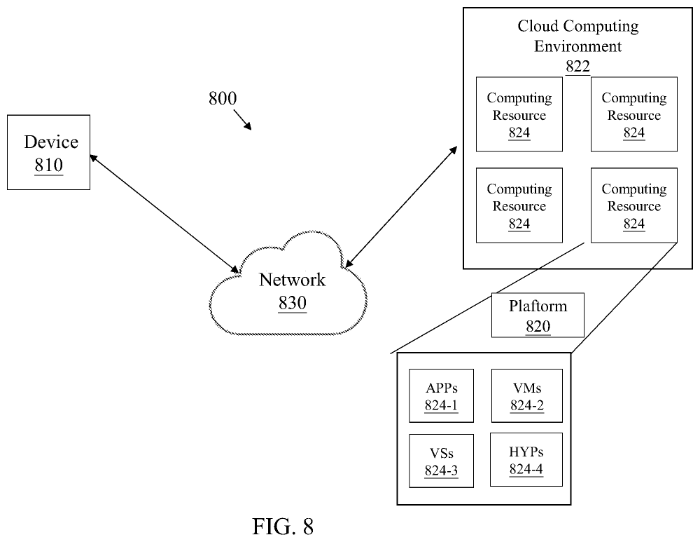

FIG. 8 illustrates a diagram of an example environment 800 in which systems and/or methods, described herein, may be implemented. As shown in FIG. 8, environment 800 may include a device 810, a platform 820, and a network 830. Devices of environment 800 may interconnect via wired connections, wireless connections, or a combination of wired and wireless connections. In some embodiments, any of the functions and operations described with reference to FIG. 1 to FIG. 7 above may be performed by any combination of elements illustrated in FIG. 8.

According to embodiments, the SPL system described herein may be stored, hosted, or deployed in the cloud computing platform 820. In this regard, device 810 may include a device, system, equipment, or the like, utilized by the user (e.g., user of a marketing team, user of a network planning team, etc.) to access the SPL system. In that case, device 810 may include one or more devices capable of receiving, generating, storing, processing, and/or providing information associated with platform 820.

Platform 820 includes one or more devices capable of receiving, generating, storing, processing, and/or providing information. In some implementations, platform 820 may include a cloud server or a group of cloud servers. In some implementations, platform 820 may be designed to be modular such that certain software components may be swapped in or out depending on a particular need. As such, platform 820 may be easily and/or quickly reconfigured for different uses.

In some implementations, as shown, platform 820 may be hosted in cloud computing environment 822. Notably, while implementations described herein describe platform 820 as being hosted in cloud computing environment 822, in some implementations, platform 820 may not be cloud-based (i.e., may be implemented outside of a cloud computing environment) or may be partially cloud-based.

Cloud computing environment 822 includes an environment that hosts platform 820. Cloud computing environment 822 may provide computation, software, data access, storage, etc. services that do not require end-user (e.g., user device 810) knowledge of a physical location and configuration of system(s) and/or device(s) that hosts platform 820. As shown, cloud computing environment 822 may include a group of computing resources 824 (referred to collectively as “computing resources 824” and individually as “computing resource 824”).

Computing resource 824 includes one or more personal computers, a cluster of computing devices, workstation computers, server devices, or other types of computation and/or communication devices. In some implementations, computing resource 824 may host platform 820. The cloud resources may include compute instances executing in computing resource 824, storage devices provided in computing resource 824, data transfer devices provided by computing resource 824, etc. In some implementations, computing resource 824 may communicate with other computing resources 824 via wired connections, wireless connections, or a combination of wired and wireless connections.

As further shown in FIG. 8, computing resource 824 includes a group of cloud resources, such as one or more applications (“APPs”) 824-1, one or more virtual machines (“VMs”) 824-2, virtualized storage (“VSs”) 824-3, one or more hypervisors (“HYPs”) 824-4, or the like. While the current example embodiment is with reference to virtualized network functions, it is understood that one or more other embodiments are not limited thereto, and may be implemented in at least one of containers, cloud-native services, one or more container platforms, etc. For example, in one or more other example embodiments, any of the above-described components may be a software-based component deployed or hosted in, for example, a server cluster such as a hybrid cloud server, data center servers, and the like. The software-based component may be containerized and may be deployed and controlled by one or more machines, called “nodes”, that run or execute the containerized network elements and are addressable. In this regard, a server cluster may contain at least one master node and a plurality of worker nodes, wherein the master node(s) controls and manages a set of associated worker nodes.

Application 824-1 includes one or more software applications that may be provided to or accessed by user device 810. Application 824-1 may eliminate a need to install and execute the software applications on user device 810. For example, application 824-1 may include software associated with platform 820 and/or any other software capable of being provided via cloud computing environment 822. In some implementations, one application 824-1 may send/receive information to/from one or more other applications 824-1, via virtual machine 824-2.

Virtual machine 824-2 includes a software implementation of a machine (e.g., a computer) that executes programs like a physical machine. Virtual machine 824-2 may be either a system virtual machine or a process virtual machine, depending upon use and degree of correspondence to any real machine by virtual machine 824-2. A system virtual machine may provide a complete system platform that supports execution of a complete operating system (“OS”). A process virtual machine may execute a single program, and may support a single process. In some implementations, virtual machine 824-2 may execute on behalf of a user (e.g., user device 810), and may manage infrastructure of cloud computing environment 822, such as data management, synchronization, or long-duration data transfers.

Virtualized storage 824-3 includes one or more storage systems and/or one or more devices that use virtualization techniques within the storage systems or devices of computing resource 824. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 824-4 may provide hardware virtualization techniques that allow multiple operating systems (e.g., “guest operating systems”) to execute concurrently on a host computer, such as computing resource 824. Hypervisor 824-4 may present a virtual operating platform to the guest operating systems, and may manage the execution of the guest operating systems. Multiple instances of a variety of operating systems may share virtualized hardware resources.

Network 830 may include one or more wired and/or wireless networks. For example, network 830 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 8 are provided as an example. In practice, there may be additional devices and/or networks, fewer devices and/or networks, different devices and/or networks, or differently arranged devices and/or networks than those shown in FIG. 8. Furthermore, two or more devices shown in FIG. 8 may be implemented within a single device, or a single device shown in FIG. 8 may be implemented as multiple, distributed devices. Additionally, or alternatively, a set of devices (e.g., one or more devices) of environment 800 may perform one or more functions described as being performed by another set of devices of environment 800.

### Various Aspects of Embodiments

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a microservice(s) module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Various further respective aspects and features of embodiments of the present disclosure may be defined by the following items:
Item [1]: A system that may include: a memory storage storing computer-executable instructions; and at least one processor communicatively coupled to the memory storage, wherein the at least one processor may be configured to execute the instructions to: receive at least one software part from a user, wherein the received at least one software part is a new version of at least one of a plurality of software parts specified in a list; determine whether the received at least one software part passes a quality check; in response to determining that the received at least one software part passes the quality check: add the received software part to the list; and perform a first validation of the list; wherein each of the plurality of software parts specified in the list include one or more indication of a type of the quality check which a respective one of the plurality of software parts in the list passes.
Item [2]: The system according to item [1], wherein the quality check may include one or more of security check, safety check, performance check, and power consumption check.
Item [3]: The system according to any one of items [1]-[2], wherein: the one or more indication may include a cryptographic signature resulting from a respective one of the plurality of software parts specified in the list being cryptographically signed; and the cryptographic signature may indicate an entity that is responsible for performing the type of the quality check which a respective one of the plurality of software parts in the list passes.
Item [4]: The system according to any one of items [1]-[3], wherein the at least one processor may be further configured to execute the instructions to: perform the quality check on the received at least one software part; and perform a second validation of the received at least one software part based on a type of the quality check which the received at least one software part passes; wherein the at least one processor may be configured to execute the instructions to determine whether the received at least one software part passes the quality check by determining whether a result of performing the quality check on the received at least one software part satisfies a threshold.
Item [5]: The system according to item [4], wherein: the threshold may include a quality gate; and the quality gate may define a level of quality which the received at least one software part should meet.
Item [6]: The system according to any one of items [1]-[5], wherein the at least one processor may be further configured to execute the instructions to: transmit the received at least one software part to a checking entity; and receive a result of performing the quality check on the received at least one software part from the checking entity; wherein the at least one processor may be configured to execute the instructions to determine whether the received at least one software part passes the quality check by determining whether the received result indicates that the checking entity has performed a second validation of the received at least one software part based on a type of the quality check which the received at least one software part passes from the checking entity.
Item [7]: The system according to any one of items [1]-[6], wherein the list may include a Software Bill of Material (SBOM).
Item [8]: The system according to any one of items [1]-[7], wherein the at least one processor may be further configured to execute the instructions to, in response to determining that the received at least one software part fails the quality check, provide a failure notification to the user; and wherein the failure notification may indicate a type of the quality check which the received at least one software part fails.
Item [9]: The system according to any one of items [1]-[8], wherein the at least one processor may be further configured to execute the instructions to: in response to determining that the received at least one software part fails the quality check, determine whether the received at least one software part has at least one dependent software part that should receive the quality check based on a type of the quality check which the received at least one software part fails, wherein the at least one dependent software part may be at least one software part in the plurality of software parts that depends from the received at least one software part; and in response to determining that the received at least one software part has at least one dependent software part that should receive the quality check, perform the quality check on the at least one dependent software part.
Item [10]: The system according to any one of items [1]-[9], wherein the at least one processor may be configured to execute the instructions to perform the first validation of the list by cryptographically signing the list.
Item [11]: A method that may include: receiving at least one software part from a user, wherein the received at least one software part is a new version of at least one of a plurality of software parts specified in a list; determining whether the received at least one software part passes a quality check; in response to determining that the received at least one software part passes the quality check: adding the received software part to the list; and perform a first validation of the list; wherein each of the plurality of software parts specified in the list include one or more indication of a type of the quality check which a respective one of the plurality of software parts in the list passes.
Item [12]: The method according to item [11], wherein the quality check may include one or more of security check, safety check, performance check, and power consumption check.
Item [13]: The method according to any one of items [11]-[12], wherein: the one or more indication may include a cryptographic signature resulting from a respective one of the plurality of software parts specified in the list being cryptographically signed; and the cryptographic signature may indicate an entity that is responsible for performing the type of the quality check which a respective one of the plurality of software parts in the list passes.
Item [14]: The method according to any one of items [11]-[13], may further include: performing the quality check on the received at least one software part; and performing a second validation of the received at least one software part based on a type of the quality check which the received at least one software part passes; wherein the determining whether the received at least one software part passes the quality check may include determining whether a result of performing the quality check on the received at least one software part satisfies a threshold.
Item [15]: The method according to item [14], wherein: the threshold may include a quality gate; and the quality gate may define a level of quality which the received at least one software part should meet.
Item [16]: The method according to any one of items [11]-[15], may further include: transmitting the received at least one software part to a checking entity; and receiving a result of performing the quality check on the received at least one software part from the checking entity; wherein the determining whether the received at least one software part passes the quality check may include determining whether the received result indicates that the checking entity has performed a second validation of the received at least one software part based on a type of the quality check which the received at least one software part passes from the checking entity.
Item [17]: The method according to any one of items [11]-[16], wherein the list may include a Software Bill of Material (SBOM).
Item [18]: The method according to any one of items [11]-[17], may further include, in response to determining that the received at least one software part fails the quality check, providing a failure notification to the user; and wherein the failure notification may indicate a type of the quality check which the received at least one software part fails.
Item [19]: The method according to any one of items [11]-[18], may further include: in response to determining that the received at least one software part fails the quality check, determining whether the received at least one software part has at least one dependent software part that should receive the quality check based on a type of the quality check which the received at least one software part fails, wherein the at least one dependent software part may be at least one software part in the plurality of software parts that depends from the received at least one software part; and in response to determining that the received at least one software part has at least one dependent software part that should receive the quality check, performing the quality check on the at least one dependent software part.
Item [20]: The method according to any one of items [11]-[19], wherein performing the first validation of the list may include cryptographically signing the list.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. A system comprising:
a memory storage storing computer-executable instructions; and
at least one processor communicatively coupled to the memory storage, wherein the at least one processor is configured to execute the instructions to:
receive at least one software part from a user, wherein the received at least one software part is a new version of at least one of a plurality of software parts specified in a list;
determine whether the received at least one software part passes a quality check;
in response to determining that the received at least one software part passes the quality check:
add the received software part to the list; and
performing a first validation of the list;
wherein each of the plurality of software parts specified in the list include one or more indication of a type of the quality check which a respective one of the plurality of software parts in the list passes.

2. The system according to claim 1, wherein the quality check comprises one or more of security check, safety check, performance check, and power consumption check.

3. The system according to claim 1, wherein:
the one or more indication comprises a cryptographic signature resulting from a respective one of the plurality of software parts specified in the list being cryptographically signed; and
the cryptographic signature indicates an entity that is responsible for performing the type of the quality check which a respective one of the plurality of software parts in the list passes.

4. The system according to claim 1, wherein the at least one processor is further configured to execute the instructions to:
perform the quality check on the received at least one software part; and
perform a second validation of the received at least one software part based on a type of the quality check which the received at least one software part passes;
wherein the at least one processor is configured to execute the instructions to determine whether the received at least one software part passes the quality check by determining whether a result of performing the quality check on the received at least one software part satisfies a threshold.

5. The system according to claim 4, wherein:
the threshold comprises a quality gate; and
the quality gate defines a level of quality which the received at least one software part should meet.

6. The system according to claim 1, wherein the at least one processor is further configured to execute the instructions to:
transmit the received at least one software part to a checking entity; and
receive a result of performing the quality check on the received at least one software part from the checking entity;
wherein the at least one processor is configured to execute the instructions to determine whether the received at least one software part passes the quality check by determining whether the received result indicates that the checking entity has performed a second validation of the received at least one software part based on a type of the quality check which the received at least one software part passes from the checking entity.

7. The system according to claim 1, wherein the list comprises a Software Bill of Material (SBOM).

8. The system according to claim 1, wherein the at least one processor is further configured to execute the instructions to, in response to determining that the received at least one software part fails the quality check, provide a failure notification to the user; and wherein the failure notification indicates a type of the quality check which the received at least one software part fails.

9. The system according to claim 1, wherein the at least one processor is further configured to execute the instructions to:
in response to determining that the received at least one software part fails the quality check, determine whether the received at least one software part has at least one dependent software part that should receive the quality check based on a type of the quality check which the received at least one software part fails, wherein the at least one dependent software part is at least one software part in the plurality of software parts that depends from the received at least one software part; and
in response to determining that the received at least one software part has at least one dependent software part that should receive the quality check, perform the quality check on the at least one dependent software part.

10. The system according to claim 1, wherein the at least one processor is configured to execute the instructions to perform the first validation of the list by cryptographically signing the list.

11. A method comprising:
receiving at least one software part from a user, wherein the received at least one software part is a new version of at least one of a plurality of software parts specified in a list;
determining whether the received at least one software part passes a quality check;
in response to determining that the received at least one software part passes the quality check:
adding the received software part to the list; and
perform a first validation of the list;
wherein each of the plurality of software parts specified in the list include one or more indication of a type of the quality check which a respective one of the plurality of software parts in the list passes.

12. The method according to claim 11, wherein the quality check comprises one or more of security check, safety check, performance check, and power consumption check.

13. The method according to claim 11, wherein:
the one or more indication comprises a cryptographic signature resulting from a respective one of the plurality of software parts specified in the list being cryptographically signed; and
the cryptographic signature indicates an entity that is responsible for performing the type of the quality check which a respective one of the plurality of software parts in the list passes.

14. The method according to claim 11, further comprising:
performing the quality check on the received at least one software part; and
performing a second validation of the received at least one software part based on a type of the quality check which the received at least one software part passes;
wherein determining whether the received at least one software part passes the quality check comprises determining whether a result of performing the quality check on the received at least one software part satisfies a threshold.

15. The method according to claim 14, wherein:
the threshold comprises a quality gate; and
the quality gate defines a level of quality which the received at least one software part should meet.

16. The method according to claim 11, further comprising:
transmitting the received at least one software part to a checking entity; and
receiving a result of performing the quality check on the received at least one software part from the checking entity;
wherein determining whether the received at least one software part passes the quality check comprises determining whether the received result indicates that the checking entity has performed a second validation of the received at least one software part based on a type of the quality check which the received at least one software part passes from the checking entity.

17. The method according to claim 11, wherein the list comprises a Software Bill of Material (SBOM).

18. The method according to claim 11, further comprising, in response to determining that the received at least one software part fails the quality check, providing a failure notification to the user; wherein the failure notification indicates a type of the quality check which the received at least one software part fails.

19. The method according to claim 11, further comprising:
in response to determining that the received at least one software part fails the quality check, determining whether the received at least one software part has at least one dependent software part that should receive the quality check based on a type of the quality check which the received at least one software part fails, wherein the at least one dependent software part is at least one software part in the plurality of software parts that depends from the received at least one software part; and
in response to determining that the received at least one software part has at least one dependent software part that should receive the quality check, performing the quality check on the at least one dependent software part.

20. The method according to claim 11, wherein performing the first validation of the list comprises cryptographically signing the list.
